(19) United States
(12) Patent Application Publication
(10) Pub. No.: US 2024/0254364 A1
(43) Pub. Date: Aug. 1, 2024

(54) POLISHING COMPOSITION, POLISHING METHOD USING THE POLISHING COMPOSITION, AND METHOD FOR PRODUCING METALLIC MOLD USING THE POLISHING COMPOSITION

(71) Applicant: FUJIMI INCORPORATED, Kiyosu-shi (JP)

(72) Inventors: Hitoshi MORINAGA, Kiyosu-shi (JP); Yuta YAMADA, Kiyosu-shi (JP); Kazutoshi HOTTA, Kiyosu-shi (JP); Yuuichi ITO, Kiyosu-shi (JP)

(73) Assignee: FUJIMI INCORPORATED, Kiyosu-shi (JP)

(21) Appl. No.: 18/423,589

(22) Filed: Jan. 26, 2024

(30) Foreign Application Priority Data
Jan. 27, 2023 (JP) 2023-010768
Sep. 29, 2023 (JP) 2023-169153
Jan. 22, 2024 (JP) 2024-007213

(51) Int. Cl. C09G 1/02

(52) U.S. Cl. CPC C09G 1/02

(57) ABSTRACT

The present invention provides a polishing composition which is capable of rapidly removing scratches and exhibits a high polishing rate without deteriorating surface quality. One aspect of the present invention relates to the polishing composition contains abrasive grains having a Mohs hardness of 8 or more, and a dispersing medium, wherein the abrasive grains have two or more local maximum points at different particle sizes in a volume-based particle size distribution measured by a porous electrical resistance method.

### CROSS-REFERENCE

The present application is based on Japanese Patent Application No. 2023-010768 filed on Jan. 27, 2023, Japanese Patent Application No. 2023-169153 filed on Sep. 29, 2023, and Japanese Patent Application No. 2024-7213 filed on Jan. 22, 2024, the disclosures of which are incorporated by reference in their entirety.

### TECHNICAL FIELD

The present invention relates to a polishing composition, a polishing method using the polishing composition, and a method for producing a metallic mold using the polishing composition.

### BACKGROUND ART

The surfaces of materials such as metals, glass, ceramics, resins, and diamond are required to be smoothed in some uses. For smoothing the surfaces of these various materials, polishing is performed using hard abrasive grains having a high Mohs hardness, such as those from diamond. For example, metals which have a steric structure (three-dimensional shape) and are used as metallic molds for pressing, forging, casting, die casting, plastic, glass, rubber, powder metallurgy, and the like are subjected to cutting and processing, and then polished by polishing with abrasive stone and sandpaper, followed by finishing with a hard abrasive grain (for example, diamond) paste. In this way, scratches on a metal surface are removed to obtain a smooth surface. For example, Japanese Patent Laid-Open No. 2004-66384 discloses a diamond paste comprising oil, a metallic soap, and diamond grains.

### SUMMARY OF INVENTION

In recent years, the shortened product life cycles have forced many enterprises to reduce the production period, experience intense price competition, and face the challenge of cost improvement. Under these circumstances, a polishing composition is desired which enables polishing operations to be performed in a shorter time than before.

Accordingly, an object of the present invention is to provide a polishing composition which is capable of rapidly removing scratches and exhibits a high polishing rate without deteriorating surface quality.

In view of the above-described problem, the present inventors have extensively conducted studies. As a result, the present inventors have found that the above-described problem is solved by a polishing composition comprising abrasive grains having a Mohs hardness of 8 or more, and a dispersing medium, wherein the abrasive grains have two or more local maximum points at different particle sizes in a volume-based particle size distribution measured by a porous electrical resistance method. Thus, the present invention has been completed.

### BRIEF DESCRIPTION OF DRAWING

FIG. 1 is a conceptual diagram of a particle size distribution of abrasive grains contained in a polishing composition of the present invention.

### DESCRIPTION OF EMBODIMENTS

Hereinafter, modes for carrying out the present invention will be described in detail. Embodiments shown herein are illustrated for embodying the technical concept of the present invention, and should not be construed as limiting the present invention. Accordingly, other modes, use methods, operational techniques, and the like which can be conceived by, for example, those skilled in the art without departing from the spirit of the present invention are all within the scope and spirit of the present invention, as well as the scope of the inventions set forth in claims, and their equivalents. Embodiments described in the present specification may be arbitrarily combined to provide other embodiments.

In the present specification, the term “X to Y” indicating a range means “X or more and Y or less”, and the terms “weight”, “wt %”, and “parts by weight” are regarded as being synonymous with the terms “mass”, “mass %”, and “parts by mass”, respectively. In the present specification, operations and measurement of physical properties and the like are performed under conditions of room temperature (20° ° C. or higher and 25° C. or lower) and a relative humidity of 40% RH or more and 50% RH or less unless otherwise specified.

### <Polishing Composition>

An aspect of the present invention is a polishing composition comprising abrasive grains having a Mohs hardness of 8 or more, and a dispersing medium, wherein the abrasive grains have two or more local maximum points at different particle sizes in a volume-based particle size distribution measured by a porous electrical resistance method. With a polishing composition having such a configuration, scratches on surfaces of metals, semiconductor substrate, glass, ceramics, resins, diamond, and the like, in particular, the surface of metals, can be rapidly removed, and an object to be polished can be polished at a high polishing rate without deteriorating surface quality.

That is, according to the present invention, there is provided a polishing composition which is capable of rapidly removing scratches and exhibits a high polishing rate without deteriorating surface quality.

In the polishing composition, the abrasive grains exist as an aggregate of grains while having a particle size distribution. With regard to the particle size distribution, the present inventors have found that a specific particle size distribution considerably contributes to the polishing rate and the ease of removing scratches existing on surfaces to be polished. Specifically, the present inventors have found that by using abrasive grains having a broad particle size distribution (that is, abrasive grains having two or more local maximum points at different particle sizes in a volume-based particle size distribution measured by a porous electrical resistance method), the polishing rate and the scratch removal performance are markedly improved.

The presumed mechanism thereof is as follows although the details are unknown. Abrasive grains having a small particle size can enter gaps generated when large-sized grains are arranged on a surface to be polished. It is presumed that since the polishing composition of the present invention has a broad particle size distribution and thus includes abrasive grains having a small particle size, it forms a state in which abrasive grains are more densely packed as described above, on a surface to be polished. It is considered that this enables the abrasive grains to apply a stronger mechanical force to the surface to be polished, so that the surface to be polished can be efficiently polished, and scratches existing on the surface to be polished can be rapidly removed.

The above-described mechanism is based on presumptions, and the present invention is in no way limited to the mechanism.

Hereinafter, the components contained in the polishing composition of the present invention will be described.

### [Abrasive Grains]

The polishing composition of the present invention contains abrasive grains having a Mohs hardness of 8 or more. The abrasive grains have an action of mechanically polishing an object to be polished. Here, the Mohs hardness refers to a method in which reference minerals with hardnesses of 1 to 10 are set, a reference material and a measurement material are rubbed with each other, and the hardness is measured on the basis of existence or non-existence of scratches. As the reference material for the Mohs hardness, talc is used for a Mohs hardness of 1, gypsum is used for a Mohs hardness of 2, calcite is used for a Mohs hardness of 3, fluorite is used for a Mohs hardness of 4, apatite is used for a Mohs hardness of 5, orthoclase is used for a Mohs hardness of 6, quartz is used for a Mohs hardness of 7, topaz (yellow jade/Ogyoku) is used for a Mohs hardness of 8, corundum (Kogyoku) is used for a Mohs hardness of 9, and diamond (Kongoseki) is used for a Mohs hardness of 10.

Examples of abrasive grains having a Mohs hardness of 8 or more include those from tungsten carbide (Mohs hardness: 8), zirconium boride (Mohs hardness: 8), aluminum nitride (Mohs hardness: 8), aluminum oxides (Mohs hardness: 9) such as sintered alumina and fused alumina, titanium nitride (Mohs hardness: 9), titanium carbide (Mohs hardness: 9), tantalum carbide (Mohs hardness: 9), zirconium carbide (Mohs hardness: 9), chromium (Mohs hardness: 9), aluminum boride (Mohs hardness: 9), boron carbide (Mohs hardness: 9), silicon carbide (Mohs hardness: 9), cubic boron nitride (cBN, Mohs hardness: 9.5), boron carbide (Mohs hardness: 9.5), titanium boride (Mohs hardness: 9.5), and diamond (Mohs hardness: 10). Among them, silicon carbide and diamond can be preferably used. Silicon carbide can be suitably used when the object to be polished is soft metals (for example, aluminum alloy, titanium alloy, etc.), and is excellent in terms of cost. Diamond is more preferably used because it has excellent scratch removal properties. When a plurality of types of abrasive grains are mixed, it is only required that the Mohs hardness of the main component of the abrasive grain be 8 or more. Here, the term “main component of the abrasive grain” means a component contained in an amount of more than 50 mass % of the abrasive grains. In an embodiment, the abrasive grains having a Mohs hardness of 8 or more is contained in an amount of preferably 60 mass % or more, more preferably 70 mass % or more, further more preferably 80 mass % or more, particularly preferably 90 mass % or more, most preferably 95 mass % or more of the abrasive grains of the polishing composition according to the present embodiment.

The abrasive grains for use in the present invention have two or more local maximum points at different particle sizes in a volume-based particle size distribution measured by a porous electrical resistance method. The number of local maximum points may be 2, 3, or 4 or more. In the polishing composition of the present invention, the number of local maximum values in the volume-based particle size distribution is preferably 2 or more and 5 or less, more preferably 2 or more and 4 or less, further more preferably 2 or 3, particularly preferably 2.

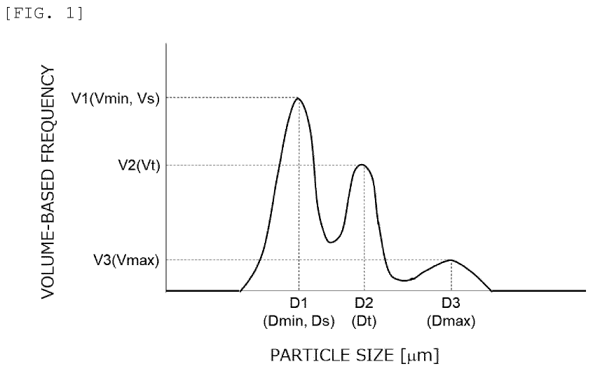

The abrasive grains according to one embodiment will be described in detail with reference to FIG. 1. FIG. 1 is a conceptual diagram showing a particle size distribution of abrasive grains contained in the polishing composition of one embodiment.

FIG. 1 shows a conceptual diagram of a particle size distribution (volume-based) of abrasive grains having three local maximum points as an example. In the particle size distribution of FIG. 1, the vertical axis represents a volume-based relative number of grains (hereinafter, a “volume-based frequency”) indicated by a straight (normal) scale, and the horizontal axis represents a particle size (um) indicated by a logarithmic scale. It is to be noted that the particle size distribution of abrasive grains shown in FIG. 1 is just a conceptual diagram, and does not limit the abrasive grains contained in the polishing composition of one embodiment. The particle size distribution of FIG. 1 has local maximum points of volume-based frequencies (that is, peak heights) V1, V2, and V3 at particle sizes D1, D2, and D3, respectively.

Here, among two or more particle sizes having local maximum points in the volume-based particle size distribution, the smallest particle size is Dmin and the largest particle size is Dmax. That is, in the particle size distribution of FIG. 1, D1 corresponds to Dmin, and D3 corresponds to Dmax. For the particle size having a local maximum point with the largest volume-based frequency (that is, peak height) and the particle size having a local maximum point with the second largest volume-based frequency (that is, peak height), among two or more particle sizes having local maximum points in the volume-based particle size distribution, the particle size on the small particle size side is Ds and the particle size on the large particle size side is Dt. That is, in the particle size distribution of FIG. 1, DI corresponds to Ds and D2 corresponds to Dt. The volume-based frequencies at particle sizes Dmin, Dmax, Ds, and Dt are Vmin, Vmax, Vs, and Vt, respectively. In the particle size distribution of FIG. 1, D1 is Dmin as well as Ds.

For example, when the volume-based particle size distribution has two local maximum points, Vmin is Ds and Dmax is Dt.

When the particle sizes, the local maximum points of which are adjacent in the particle size distribution, are 0.05 μm or less, the adjacent local maximum points are not regarded as separate local maximum points, but the adjacent peaks are considered collectively as one peak, and of these particle sizes, the particle size with the largest volume-based frequency is regarded as a local maximum point.

In the present specification, the particle size distribution of abrasive grains is based on a porous electrical resistance method, specifically International Standard ISO 13319: 2021, Determination of particle size distribution-Electrical sensing zone method. Examples of the particle size and measurement apparatus include a measurement apparatus described in Examples. In measurement based on International Standard ISO (ISO 13319: 2021), an aperture (porous tube) having a diameter corresponding to the particle size is used. In the case where local maximum points in the particle size distribution of abrasive grains are apart from each other, so that all local maximum points cannot be detected with one aperture, it is possible to detect all local maximum points using two or more apertures.

In the abrasive grains used for the polishing composition of the present invention, the ratio of the smallest particle size (Dmin) to the largest particle size (Dmax) in two or more local maximum points at different particle sizes (that is, ratio of Dmin to Dmax), Dmin/Dmax, in the particle size distribution is preferably 0.05 or more, more preferably 0.1 or more, further more preferably 0.2 or more, particularly preferably 0.3 or more, most preferably 0.4 or more. The Dmin/Dmax in the particle size distribution of abrasive grains is preferably 0.9 or less, more preferably 0.85 or less, further more preferably 0.8 or less, particularly preferably 0.7 or less, most preferably 0.6 or less. That is, the Dmin/Dmax in the particle size distribution of abrasive grains is preferably 0.05 or more and 0.9 or less, more preferably 0.1 or more and 0.85 or less, further more preferably 0.2 or more and 0.8 or less, particularly preferably 0.3 or more and 0.7 or less, most preferably 0.4 or more and 0.6 or less. When the Dmin/Dmax in the abrasive grains is in the above-described range, abrasive grains are likely to be more densely packed, so that the expected effect of the present invention is exhibited to a greater extent. In an embodiment, the Dmin/Dmax of the abrasive grains is 0.1 or more and 0.9 or less.

The ratio of Vmin to Vmax, Vmin/Vmax, is not limited, and is preferably 0.01 or more, more preferably 0.05 or more, further more preferably 0.1 or more, particularly preferably 0.2 or more, most preferably 0.3 or more. The Vmin/Vmax is preferably 5.0 or less, more preferably 3.5 or less, further more preferably 3.0 or less, particularly preferably 2.5 or less, most preferably 2.0 or less. When the Vmin/Vmax in the abrasive grains is in the above-described range, grains are likely to be more densely packed, so that the expected effect of the present invention is exhibited to a greater extent.

In abrasive grains according to an embodiment, the ratio of Vs to Vt, Vs/Vt, is 3.5 or less, where Vs is a volume-based frequency at a particle size (Ds) on the small particle size side and Vt is a volume-based frequency at a particle size (Dt) on the large particle size side for the particle size with the largest volume-based frequency and the particle size with the second largest volume-based frequency in local maximum points at different particle sizes in a particle size distribution. That is, a particle size (Ds) has a volume-based frequency Vs with either of the largest or the second largest volume-based frequency at the smaller particle size, and a particle size (Dt) has a volume-based frequency Vt with either of the largest or the second largest volume-based frequency at the larger particle size, in local maximum points at different particle sizes in a particle size distribution. The Vs/Vt in the particle size distribution of abrasive grains is preferably 0.05 or more, more preferably 0.1 or more, further more preferably 0.2 or more, particularly preferably 0.3 or more, most preferably more than 0.3. The Vs/Vt in the particle size distribution of abrasive grains is preferably 5.0 or less, more preferably 3.5 or less, further more preferably 3.0 or less, particularly preferably 2.5 or less, most preferably 2.0 or less. When the Vs/Vt in the abrasive grains is in the above-described range, grains are likely to be more densely packed, so that the expected effect of the present invention is exhibited to a greater extent.

The Dmin value of the abrasive grains is preferably 0.1 μm or more, more preferably 0.5 μm or more, further more preferably 1.0 μm or more, particularly preferably 1.1 μm or more, even more preferably 1.5 μm or more, most preferably 2.0 μm or more. The Dmin value of the abrasive grains is not limited, and is preferably 5.0 μm or less, more preferably 4.0 μm or less, further more preferably 3.5 μm or less, particularly preferably 3.0 μm or less, most preferably 2.9 μm or less. When the Dmin of the abrasive grains is in the above-described range, the mechanical action of grains is enhanced, so that the expected effect of the present invention is exhibited to a greater extent. In an embodiment, the Dmin value of the abrasive grains is 0.3 μm or more and less than 3.0 μm. When the particle size distribution has two local maximum points, the Dmin value of the abrasive grains is preferably 0.4 μm or more and 2.5 μm or less, more preferably 1.0 μm or more and 2.3 μm or less. When the particle size distribution has three or more local maximum points, the Dmin value of the abrasive grains is preferably 0.3 μm or more and 2.9 μm or less, more preferably 1.0 μm or more and 2.9 μm or less, further more preferably 2.0 μm or more and 2.9 μm or less. When the Dmin of the abrasive grains is in the above-described range, the mechanical action of grains is enhanced, so that the expected effect of the present invention is exhibited to a greater extent.

The Dmax value of the abrasive grains is preferably 1.0 μm or more, more preferably 1.5 μm or more, further more preferably 1.8 μm or more, particularly preferably 2.0 μm or more, most preferably more than 2.0 μm. The Dmax value of the abrasive grains is not limited, and is preferably 9.0 μm or less, more preferably 8.5 μm or less, further more preferably 8.0 μm or less, particularly preferably 7.5 μm or less, most preferably 7.0 μm or less. When the Dmax of the abrasive grains is in the above-described range, the mechanical action of grains is enhanced, so that the expected effect of the present invention is exhibited to a greater extent. In an embodiment, the Dmax value of the abrasive grains is 3.0 μm or more and 6.5 μm or less. When the particle size distribution has two local maximum points, the Dmax value of the abrasive grains is preferably 3.5 μm or more and 5.5 μm or less, more preferably 3.8 μm or more and 5.0 μm or less. When the particle size distribution has three or more local maximum points, the Dmax value of the abrasive grains is preferably 3.5 μm or more and 8.5 μm or less, more preferably 4.0 μm or more and 8.0 μm or less. When the Dmax of the abrasive grains is in the above-described range, the mechanical action of grains is enhanced, so that the expected effect of the present invention is exhibited to a greater extent.

When there are two local maximum values, the Ds value of the abrasive grains is equal to Dmin, and therefore the above-described Dmin value may be applied as Ds. When there are three or more local maximum values, the Ds value of the abrasive grains is preferably 0.1 μm or more, more preferably 0.5 μm or more, further more preferably 1.0 μm or more, particularly preferably 1.1 μm or more, even more preferably 1.5 μm or more, most preferably 2.0 μm or more. The Ds value of the abrasive grains is not limited, and is preferably 5.0 μm or less, more preferably 4.0 μm or less, further more preferably 3.5 μm or less, particularly preferably 3.0 μm or less, most preferably 2.9 μm or less. When the Ds of the abrasive grains is in the above-described range, the mechanical action of grains is enhanced, so that the expected effect of the present invention is exhibited to a greater extent.

When there are two local maximum values, the Dt value of the abrasive grains is equal to Dmax, and therefore the above-described Dmax value may be applied as Dt. When there are three or more local maximum values, the Dt value of the abrasive grains is not limited, and is preferably 1.0 μm or more, more preferably 1.5 μm or more, further more preferably 1.8 μm or more, particularly preferably 2.0 μm or more, most preferably more than 2.0 μm. The Dt value of the abrasive grains is not limited, and is preferably 9.0 μm or less, more preferably 8.5 μm or less, further more preferably 8.0 μm or less, particularly preferably 7.5 μm or less, most preferably 7.0 μm or less. When the Dt of the abrasive grains is in the above-described range, the mechanical action of grains is enhanced, so that the expected effect of the present invention is exhibited to a greater extent.

One type of abrasive grains may be used alone as long as there are two or more local maximum points at different particle sizes, or two or more types of abrasive grains may be used in combination so that there are two or more local maximum points. As the abrasive grains, a commercial product may be used, or a synthetic product may be used.

Here, for the abrasive grains having two or more local maximum points at different particle sizes, synthesis conditions may be adjusted so that the particle size distribution has two or more local maximum points at different particle sizes, or natural abrasive grains or artificial abrasive grains may be adjusted to a desired size (particle size distribution). For example, the artificial abrasive grains may be produced, or acquired as a commercial product, and then crushed by ball milling, air flow grinding, or the like for adjustment to a desired size. The crushed abrasive grains may be classified with a sieve or the like to obtain abrasive grains having a desired size (particle size distribution), or classified abrasive grains may be mixed so as to form abrasive grains having a desired size (particle size distribution).

When the abrasive grains are diamond, the diamond is, for example, natural diamond or artificial diamond, preferably artificial diamond. The artificial diamond is not limited, and artificial diamond synthesized by a known method such as a high-pressure high-temperature (HPHT) method, a chemical vapor deposition (CVD) method, or a detonation method may be used. The artificial diamond may be single-crystalline diamond or polycrystalline diamond, or single-crystalline diamond and polycrystalline diamond may be used in combination. The single-crystalline diamond is preferable from the viewpoint of cost. Further, polycrystalline diamond is preferable from the viewpoint of scratch removability.

Examples of the commercial product of diamond include those manufactured by Kemet Japan Co., Ltd., Techno Rise Corporation, Tomei Diamond Corporation, Opticanics, Inc., NAKANISHI INC., Pureon Ltd., and Nagase Abrasive Materials Co., Ltd.

The content of the abrasive grains in the polishing composition is preferably 0.01 mass % or more and 35 mass % or less with respect to the total mass of the polishing composition. When the polishing composition is a paste, the content of the abrasive grains is more preferably 0.1 mass % or more and 30 mass % or less, further more preferably 0.5 mass % or more and 25 mass % or less, particularly preferably 0.7 mass % or more and 20 mass % or less, most preferably 1 mass % or more and 15 mass % or less with respect to the total mass of the polishing composition. When the polishing composition is an abrasive grain dispersion liquid used for wraps and the like, the content of the abrasive grains is preferably 0.01 mass % or more and 25 mass % or less, more preferably 0.05 mass % or more and 20 mass % or less, further more preferably 0.1 mass % or more and 15 mass % or less, particularly preferably 0.3 mass % or more and 13 mass % or less, most preferably 0.5 mass % or more and 10 mass % or less with respect to the total mass of the polishing composition. When the content of the abrasive grains is within the above-described range, a sufficient polishing rate can be obtained, and scratches on the surface can be rapidly removed.

In the present invention, the abrasive grains may include only abrasive grains having a Mohs hardness of 8 or more, for example, only diamond, but may include diamond in combination with other abrasive grains. Other abrasive grains may have a Mohs hardness of less than 8. Examples of the abrasive grains that are combined include those of boron nitride, boron carbide, silicon carbide, fused alumina, ceria, and silica.

### [Dispersing Medium]

The polishing composition of the present invention contains a dispersing medium. The dispersing medium is a component for dispersing abrasive grains. The dispersing medium may be in any state such as a liquid, solid, or gel state, and is preferably liquid at room temperature (25° C.). For example, the polishing composition comprising abrasive grains and a dispersing medium is an abrasive grain dispersion liquid when a liquid is used as the dispersing medium, and the polishing composition comprising abrasive grains and a dispersing medium is an abrasive grain paste when a solid or a gel is used as the dispersing medium or a thickener or the like is added to an abrasive grain dispersion liquid to improve the viscosity of the abrasive grain dispersion liquid. Thus, the polishing composition of the present invention includes an abrasive grain dispersion liquid and an abrasive grain paste. Hereinafter, the abrasive grain dispersion liquid also includes an abrasive grain paste unless otherwise indicated.

Examples of the dispersing medium include water; water-miscible hydrophilic organic solvents other than water (for example, acetone, acetonitrile, ethanol, methanol, isopropanol, glycerin, ethylene glycol, propylene glycol, oxyalkylene homopolymers, oxyalkylene copolymers, and polyoxyalkylene alkyl ethers with short-chain hydrophobic groups); and hydrophobic organic solvents (for example, aliphatic hydrocarbon compounds such as n-pentane, cyclopentane, n-hexane, cyclohexane, n-heptane, methylcyclohexane, and n-octane; aromatic hydrocarbon compounds such as benzene, toluene, and xylene; fatty acids; and oil/fat (oil and fat)). The polyoxyalkylene alkyl ether having short-chain hydrophobic groups is, for example, a polyoxyalkylene alkyl ether having an alkyl ether having 1 or more and 10 or less carbon atoms. The number of carbon atoms in the polyoxyalkylene alkyl ether is preferably 1 or more and 8 or less, more preferably 1 or more and 6 or less.

The oxyalkylene group that forms an oxyalkylene homopolymer, an oxyalkylene copolymer, or a polyoxyalkylene alkyl ether with short-chain hydrophobic groups, which is used as the dispersing medium is preferably one or more selected from an oxyethylene group and an oxypropylene group. The average number of moles of the oxyalkylene group added is preferably 2 to 30, more preferably 4 to 20.

Examples of the oxyalkylene homopolymer or the oxyalkylene copolymer which is used as the dispersing medium include polyethylene glycol, polypropylene glycol, polytetramethylene glycol, polyethylene glycol-polypropylene glycol random copolymers, polyethylene glycol-polytetramethylene glycol random copolymers, polypropylene glycol-polytetramethylene glycol random copolymers, polyethylene glycol-polypropylene glycol-polytetramethylene glycol random copolymers, polyethylene glycol-polypropylene glycol block copolymers, polypropylene glycol-polyethylene glycol-polypropylene glycol triblock copolymers, and polyethylene glycol-polypropylene glycol-polyethylene glycol triblock copolymers.

Examples of the polyoxyalkylene alkyl ether with short-chain hydrophobic groups, which is used as the dispersing medium, include polyoxyalkylene monoalkyl ethers such as polyethylene glycol monomethyl ether, polypropylene glycol monomethyl ether, polytetramethylene glycol monomethyl ether, polyethylene glycol-polypropylene glycol monomethyl ether, polyethylene glycol monoethyl ether, polypropylene glycol monoethyl ether, polytetramethylene glycol monoethyl ether, polyethylene glycol-polypropylene glycol monoethyl ether, polyethylene glycol monopropyl ether, polypropylene glycol monopropyl ether, polytetramethylene glycol monopropyl ether, polyethylene glycol-polypropylene glycol monopropyl ether, polyethylene glycol monobutyl ether, polypropylene glycol monobutyl ether, polytetramethylene glycol monobutyl ether, polyethylene glycol-polypropylene glycol monobutyl ether, polyethylene glycol monopentyl ether, polypropylene glycol monopentyl ether, polyethylene glycol monohexyl ether, polypropylene glycol monohexyl ether, polyethylene glycol monooctyl ether, polypropylene glycol monooctyl ether, polyethylene glycol monononyl ether, polypropylene glycol monononyl ether, polyethylene glycol monodecyl ether, and polypropylene glycol monodecyl ether; and polyoxyalkylene dialkyl ethers such as polyethylene glycol dimethyl ether, polypropylene glycol dimethyl ether, polytetramethylene glycol dimethyl ether, polyethylene glycol-polypropylene glycol dimethyl ether, polyethylene glycol diethyl ether, polypropylene glycol diethyl ether, polytetramethylene glycol diethyl ether, polyethylene glycol-polypropylene glycol diethyl ether, polyethylene glycol dipropyl ether, polypropylene glycol dipropyl ether, polytetramethylene glycol dipropyl ether, polyethylene glycol-polypropylene glycol dipropyl ether, polyethylene glycol dibutyl ether, polypropylene glycol dibutyl ether, polytetramethylene glycol dibutyl ether, polyethylene glycol-polypropylene glycol dibutyl ether, polyethylene glycol dipentyl ether, polypropylene glycol dipentyl ether, polyethylene glycol dihexyl ether, polypropylene glycol dihexyl ether, polyethylene glycol dioctyl ether, polypropylene glycol dioctyl ether, polyethylene glycol dinonyl ether, polypropylene glycol dinonyl ether, polyethylene glycol didecyl ether, and polypropylene glycol didecyl ether.

The polishing composition of one embodiment may contain a fatty acid as the dispersing medium. The fatty acid is preferably a linear or branched fatty acid having 8 or more and 30 or less carbon atoms, more preferably a linear or branched fatty acid having 10 or more and 26 or less carbon atoms, further more preferably a linear or branched fatty acid having 12 or more and 22 or less carbon atoms. The fatty acid may be either a saturated fatty acid or an unsaturated fatty acid.

Examples of the fatty acid include capric acid, lauric acid, myristic acid, palmitic acid, stearic acid, oleic acid, 12-hydroxystearic acid, undecylenic acid, isostearic acid, linolic acid, linoleic acid, eicosapentaenoic acid (EPA), docosahexaenoic acid (DHA), behenic acid, erucic acid, and tall acid. The fatty acids may be used alone, or in combination of two or more thereof.

In one embodiment, it is preferable that among the above-mentioned fatty acids, one or more fatty acids selected from the group consisting of lauric acid, oleic acid, myristic acid, palmitic acid, stearic acid, and linolic acid be contained in the polishing composition from the viewpoint that the entire polishing composition efficiently contributes to polishing. Since the polishing composition is liquid at room temperature, it is preferable that one or more fatty acids selected from the group consisting of oleic acid and linolic acid be contained. When a fatty acid that is solid at room temperature is used as the dispersing medium, it is preferable that the fatty acid be heated to a temperature equal to or higher than the melting point of the fatty acid to liquefy the fatty acid, and then mixed with abrasive grains, and when a fatty acid that is liquid at room temperature is used as the dispersing medium, an abrasive grain dispersion liquid can be obtained by mixing abrasive grains with the dispersing medium.

In one embodiment, a solid fatty acid (that is, lauric acid, myristic acid, palmitic acid, stearic acid, or the like as the dispersing medium) can improve the viscosity of the polishing composition while dispersing the abrasive grains, and therefore also has an action as a thickener described later.

The polishing composition of one embodiment may contain oil/fat (oil and fat) as the dispersing medium. The oil/fat has a role as a dispersing medium for dispersing abrasive grains. As the oil/fat, for example, safflower oil, grape oil, evening primrose oil, walnut oil, sunflower oil, soybean oil, cotton seed oil, corn oil, wheat germ oil, rose hip oil, borage seed oil, rice oil, sesame oil, peanut oil, pearl barley oil, rapeseed oil, linseed oil, palm oil, olive oil, wood oil, castor oil, and coconut oil can be preferably used. The oil/fats may be used alone, or in combination of two or more thereof.

In one embodiment, it is preferable that among the above-mentioned oil/fats, one or more oil/fats selected from the group consisting of rice oil, peanut oil, olive oil, and palm oil be contained in the polishing composition from the viewpoint that the entire polishing composition efficiently contributes to polishing.

The content of the dispersing medium is preferably 5 mass % or more and 90 mass % or less, more preferably 10 mass % or more and 85 mass % or less, further more preferably 15 mass % or more and 80 mass % or less, particularly preferably 20 mass % or more and 75 mass % or less, most preferably 25 mass % or more and 70 mass % or less with respect to the total mass of the polishing composition. In an embodiment, the content of the dispersing medium may be 30 mass % or more and 98 mass % or less, 35 mass % or more and 95 mass % or less, or 40 mass % or more and 93 mass % or less with respect to the total mass of the polishing composition. When the content of the dispersing medium is within the above-described range, a sufficient polishing rate can be obtained, and scratches on the surface can be rapidly removed. When two or more dispersing media are used, the total content thereof is the content of the dispersing medium.

The dispersing medium may be any of a hydrophilic organic solvent and a hydrophobic organic solvent depending on a use. Of these, a hydrophobic organic solvent is preferable, and a fatty acid or oil/fat is more preferable, from the viewpoint of the dispersibility of diamond. In an embodiment, the dispersing medium includes, for example, one or more selected from a fatty acid and oil/fat. From the viewpoint of cleanability after an object to be polished is polished, a hydrophilic organic solvent is preferable, an oxyalkylene homopolymer, an oxyalkylene copolymer, or a polyoxyalkylene alkyl ether with short-chain hydrophobic groups is more preferable, and a polyoxyalkylene alkyl ether with short-chain hydrophobic groups is further more preferable. In an embodiment, the dispersing medium includes, for example, one or more selected from an oxyalkylene homopolymer, an oxyalkylene copolymer, and a polyoxyalkylene alkyl ether with short-chain hydrophobic groups.

In an embodiment, the polishing composition of the present invention contains one or more components selected from the group consisting of a fatty acid, oil/fat, an oxyalkylene homopolymer, an oxyalkylene copolymer, and polyoxyalkylene alkyl ether with short-chain hydrophobic groups. In the polyoxyalkylene alkyl ether with short-chain hydrophobic groups, the number of carbon atoms in the alkyl group (alkyl ether group) is preferably 1 to 10. The total content of the relevant components (content (mass %) with respect to the polishing composition) corresponds to the content of the dispersing medium. When the content of such components is within the above-described range, a sufficient polishing rate can be obtained, and scratches on the surface can be rapidly removed. When two or more dispersing media are used, the total content thereof is the content of the dispersing medium.

Here, it is preferable that the polishing composition of one embodiment contain two or more dispersing media. When two or more dispersing media are used, they may be mixed and simultaneously used, or abrasive grains may be dispersed in the first dispersing medium to obtain an abrasive grain dispersion liquid, followed by addition of the second dispersing medium to the abrasive grain dispersion liquid. In an embodiment of the present invention, the first dispersing medium is a fatty acid, and the second dispersing medium is oil/fat. That is, in an embodiment, the polishing composition of the present invention contains a fatty acid and oil/fat. In this case, the content of the fatty acid is preferably 0.1 mass % or more and 30 mass % or less, more preferably 0.5 mass % or more and 28 mass % or less, further more preferably 1 mass % or more and 25 mass % or less, particularly preferably 3 mass % or more and 22 mass % or less, most preferably 5 mass % or more and 20 mass % or less with respect to the total mass of the polishing composition. In this case, the content of the oil/fat is preferably 5 mass % or more and 75 mass % or less, more preferably 10 mass % or more and 70 mass % or less, further more preferably 15 mass % or more and 65 mass % or less, particularly preferably 20 mass % or more and 60 mass % or less, most preferably 25 mass % or more and 55 mass % or less with respect to the total mass of the polishing composition. When the contents of the fatty acid and the oil/fat are within the above-described ranges, a sufficient polishing rate can be obtained, and scratches on the surface can be rapidly removed.

In an embodiment of the present invention, the first dispersing medium is a fatty acid, and the second dispersing medium is a polyoxyalkylene alkyl ether with short-chain hydrophobic groups. That is, in an embodiment, the polishing composition of the present invention contains a fatty acid, and a polyoxyalkylene alkyl ether with short-chain hydrophobic groups. In this case, the content of the fatty acid is preferably 0.1 mass % or more and 30 mass % or less, more preferably 0.5 mass % or more and 25 mass % or less, further more preferably 1 mass % or more and 20 mass % or less, particularly preferably 2 mass % or more and 15 mass % or less, most preferably 3 mass % or more and 10 mass % or less with respect to the total mass of the polishing composition. In an embodiment, the content of the fatty acid is 1 mass % or more and 12 mass % or less, or 2 mass % or more and 10 mass % or less with respect to the total mass of the polishing composition. In this case, the content of the polyoxyalkylene alkyl ether with short-chain hydrophobic groups is preferably 20 mass % or more and 95 mass % or less, more preferably 25 mass % or more and 93 mass % or less, further more preferably 30 mass % or more and 90 mass % or less, particularly preferably 35 mass % or more and 85 mass % or less, most preferably 40 mass % or more and 82 mass % or less with respect to the total mass of the polishing composition. When the contents of the fatty acid and the polyoxyalkylene alkyl ether with short-chain hydrophobic groups are within the above-described ranges, a sufficient polishing rate can be obtained, and scratches on the surface can be rapidly removed.

When the polishing composition is produced using the first dispersing medium and the second dispersing medium, the mass ratio of the first dispersing medium to the second dispersing medium is preferably 90:10 to 50:50, more preferably 85:15 to 60:40, further more preferably 82:18 to 65:35, particularly preferably 80:20 to 65:35, most preferably 77:23 to 67:33. In an embodiment, the mass ratio of the first dispersing medium to the second dispersing medium may be 80:20 to 50:50, 85:15 to 55:45, or 88:12 to 60:40. Here, the dispersing medium for dispersing abrasive grains, which is used as the first dispersing medium, is preferably a fatty acid.

### [Other Components]

The polishing composition of one embodiment may contain, in addition to abrasive grains and a dispersing medium, one or more other components selected from the group consisting of a surfactant and a thickener.

### Surfactant

The polishing composition of one embodiment may contain a surfactant. The surfactant has a role as a dispersant assisting in dispersion of diamond in a fatty acid or oil/fat as a dispersing medium in the polishing composition.

The surfactant is not limited, and examples thereof include cationic surfactants, anionic surfactants, ampholytic surfactants, and nonionic surfactants. Among them, nonionic surfactants are preferable from the viewpoint of foaming and the dispersibility of abrasive grains.

The cationic surfactant may be classified into, for example, polyoxyethylene alkylamines, alkyl alkanolamides, alkylamine salts, amine oxides, quaternary ammonium salts, and tertiary amidoamine-type surfactants. Specific examples of the cationic surfactant include cocoamine acetate, stearylamine acetate, lauryldimethylamine oxide, dimethylaminopropylamide stearate, alkyltrimethylammonium salts, alkyldimethylammonium salts, and alkylbenzyldimethylammonium salts.

The anionic surfactant that can be used in one embodiment may be classified into, for example, a sulfuric acid type, a sulfonic acid type, a phosphoric acid type, phosphonic acid type, and a carboxylic acid type. Specific examples of the anionic surfactant include alkyl sulfuric acid esters, polyoxyethylene alkyl sulfuric acid esters, polyoxyethylene alkyl sulfuric acids, alkyl sulfuric acids, alkyl ether sulfuric acid esters, higher alcohol sulfuric acid esters, alkyl phosphoric acid esters, alkyl benzenesulfonic acids, α-olefin sulfonic acids, alkyl sulfonic acids, styrenesulfonic acid, alkyl naphthalenesulfonic acids, alkyl diphenyl ether disulfonic acids, polyoxyethylene alkyl ether acetic acids, polyoxyethylene alkyl ether phosphoric acids, polyoxyethylene alkyl phosphoric acid esters, polyoxyethylene sulfosuccinic acids, alkyl sulfosuccinic acids, and salts of any of the compounds described above. A specific example of the alkyl sulfonic acid is dodecyl sulfonic acid. Other examples of the anionic surfactant include taurine-based surfactants, sarcosinate-based surfactants, isethionate-based surfactants, N-acyl acidic amino acid-based surfactants, higher fatty acid salts, and acylated polypeptides.

Specific examples of the ampholytic surfactant that can be used in the present invention include an alkyl betaine type and an alkylamine oxide type. Specific examples of the ampholytic surfactant include coco betaine, lauramidopropyl betaine, cocamidopropyl betaine, sodium lauroamphoacetate, sodium cocoamphoacetate, coconut oil fatty acid amide propyl betaine, and lauryl betaine (lauryl dimethylaminoacetic acid betaine).

The nonionic surfactant is not limited, and examples thereof include surfactants having a polyoxyalkylene group such as a polyoxyalkylene adduct. Specific examples of the polyoxyalkylene adduct include, but are not limited to, polyoxyalkylene alkyl ethers with long-chain hydrophobic groups, polyoxyalkylene aryl ethers, polyoxyalkylene alkylamines, polyoxyalkylene fatty acid esters, polyoxyalkylene glycerin ether fatty acid esters, and polyoxyalkylene sorbitan fatty acid esters. Among them, polyoxyalkylene fatty acid esters are preferable from the viewpoint of the lubricity during polishing.

Examples of the polyoxyalkylene alkyl ether with long-chain hydrophobic groups which is used as the surfactant include polyoxyalkylene alkyl ethers having an alkyl group in which the number of carbon atoms is more than 10.

The oxyalkylene group forming a polyoxyalkylene group in a surfactant having a polyoxyalkylene group is preferably one or more selected from an oxyethylene group and an oxypropylene group, more preferably an oxyethylene group. The average number of moles of the oxyalkylene group added is preferably 2 to 30, more preferably 4 to 20. The number of carbon atoms in the alkyl group of the polyoxyalkylene alkyl ether with long-chain hydrophobic groups is preferably 12 or more, more preferably 14 or more, further more preferably 16 or more, and preferably 30 or less, more preferably 20 or less, further more preferably 18 or less. That is, the number of carbon atoms in the alkyl group of the polyoxyalkylene alkyl ether with long-chain hydrophobic groups is preferably 12 or more and 30 or less, more preferably 14 or more and 20 or less, further more preferably 16 or more and 18 or less. The number of carbon atoms in the fatty acid residue of the polyoxyalkylene fatty acid ester is preferably 10 or more, more preferably 12 or more, further more preferably 14 or more, and preferably 22 or less, more preferably 20 or less, further more preferably 18 or less. That is, the number of carbon atoms in the fatty acid residue of the polyoxyalkylene fatty acid ester is preferably 10 or more and 22 or less, more preferably 12 or more and 20 or less, further more preferably 14 or more and 18 or less. The fatty acid residue may be saturated or unsaturated, and is preferably unsaturated.

Examples of the polyoxyalkylene alkyl ether type include polyoxyethylene monoundecyl ether, polyoxyethylene monododecyl ether (polyoxyethylene monolauryl ether), polyoxyethylene didodecyl ether (polyoxyethylene dilauryl ether), polyoxyethylene monotetradecyl ether (polyoxyethylene monomyristyl ether), polyoxyethylene diteteradecyl ether (polyoxyethylene dimyristyl ether), polyoxyethylene monooleyl ether, and polyoxyethylene dioleyl ether. Examples of the polyoxyalkylene aryl ether type include polyoxyethylene nonylphenyl ether, polyoxyethylene octylphenyl ether, and polyoxyethylene dodecylphenyl ether. Examples of the polyoxyalkylene alkylamine type include polyoxyethylene laurylamine, polyoxyethylene stearylamine, and polyoxyethylene oleylamine. Examples of the polyoxyalkylene fatty acid ester type include polyoxyethylene monolauric acid esters, polyoxyethylene monostearic acid esters, polyoxyethylene distearic acid esters, polyoxyethylene monooleic acid esters, and polyoxyethylene dioleic acid esters. Examples of the polyoxyalkylene glycerin ether fatty acid ester type include polyoxyethylene glycerin monolauric acid esters and polyoxyethylene glycerin ether monostearic acid esters. Examples of the polyoxyalkylene sorbitan fatty acid ester type include polyoxyethylene sorbitan monolaurate, polyoxyethylene sorbitan monopalmitate, polyoxyethylene sorbitan monostearate, polyoxyethylene sorbitan monooleate, and polyoxyethylene sorbitan trioleate.

Examples of the polyoxyalkylene adduct include polyoxyethylene sorbitol tetraoleate, polyoxyethylene castor oil, and polyoxyethylene hydrogenated castor oil.

The hydrophile-lipophile balance (HLB) of the nonionic surfactant is preferably 1 to 10, more preferably 2 to 9, further more preferably 4 to 8.

The molecular weight of the surfactant is not limited, and is preferably less than 1,000, more preferably less than 500, further more preferably less than 400. It is preferable that the molecular weight of the surfactant be calculated from the chemical formula, and adopted.

The surfactant used may be a commercial product or a synthetic product. The surfactants may be used alone, or in combination of two or more thereof.

The content of the surfactant is not limited, and is preferably 0.01 mass % or more and 25 mass % or less, more preferably 0.1 mass % or more and 23 mass % or less, further more preferably 1 mass % or more and 22 mass % or less, particularly preferably 2 mass % or more and 20 mass % or less, most preferably 5 mass % or more and 18 mass % or less with respect to the total mass of the polishing composition. In an embodiment, the content of the surfactant is 1 mass % or more and 12 mass % or less, or 2 mass % or more and 10 mass % or less with respect to the total mass of the polishing composition. When the content of the surfactant is within the above-described range, abrasive grains can be homogeneously dispersed to obtain a sufficient polishing rate, and scratches on the surface can be rapidly removed.

It is preferable that the polishing composition of one embodiment contain, as the surfactant, a nonionic surfactant, more preferably a polyoxyalkylene fatty acid ester, further more preferably a polyoxyalkylene fatty acid ester having a fatty acid having 12 to 22 carbon atoms.

In an embodiment, the polishing composition of the present invention contains a fatty acid as the dispersing medium, and a polyoxyalkylene fatty acid ester as the surfactant. That is, in an embodiment, the polishing composition of the present invention contains a fatty acid, and a polyoxyalkylene fatty acid ester. Such a configuration further improves the scratch removing property while increasing the polishing rate. More preferably, the polishing composition of one embodiment contains a fatty acid having 12 to 22 carbon atoms, and a polyoxyalkylene fatty acid ester having a fatty acid having 12 to 22 carbon atoms. In this case, the content of the fatty acid is preferably 0.5 mass % or more and 25 mass % or less, more preferably 1 mass % or more and 20 mass % or less, further more preferably 2 mass % or more and 15 mass % or less, particularly preferably 3 mass % or more and 10 mass % or less, and the content of the polyoxyalkylene fatty acid ester is preferably 0.1 mass % or more and 18 mass % or less, more preferably 0.5 mass % or more and 15 mass % or less, further more preferably 1 mass % or more and 12 mass % or less, particularly preferably 2 mass % or more and 10 mass % or less, with respect to the total mass of the polishing composition.

In an embodiment, the polishing composition of the present invention contains at least one dispersing medium selected from the group consisting of a fatty acid, oil/fat, and a polyoxyalkylene alkyl ether with short-chain hydrophobic groups, and a polyoxyalkylene fatty acid ester as a surfactant.

### Thickener

The polishing composition of one embodiment may contain a thickener. The thickener has an action of increasing the viscosity of the polishing composition to improve the stability. Examples of the thickener for use in one embodiment include inorganic compounds and wax that are solid at room temperature (25° C.). Examples of the inorganic compound include amorphous silica and bentonite, and examples of the amorphous silica include silica gel, silica sol, precipitated silica, and fumed silica. Among them, precipitated silica, silica gel, and fumed silica are preferable, and precipitated silica is more preferable, as the thickener.

When wax that is solid at room temperature is used as the thickener, a paste polishing agent composition can be prepared by heating an abrasive grain dispersion liquid to the melting point of the wax, then adding the wax to the abrasive grain dispersion liquid, and melting and homogeneously stirring the mixture, followed by cooling to room temperature. When an inorganic compound is used as the thickener, the inorganic compound may be directly added to the abrasive grain dispersion liquid, or the inorganic compound may be dispersed in the dispersing medium, followed by addition of the resulting inorganic compound dispersion liquid to the abrasive grain dispersion liquid.

The content of the thickener is not limited, and is preferably 0.1 mass % or more and 33 mass % or less, more preferably 0.5 mass % or more and 30 mass % or less, further more preferably 1 mass % or more and 27 mass % or less, particularly preferably 2 mass % or more and 25 mass % or less, most preferably 5 mass % or more and 23 mass % or less with respect to the total mass of the polishing composition. When the content of the thickener is within the above-described range, a sufficient polishing rate can be obtained, and scratches on the surface can be rapidly removed.

In addition to the abrasive grain, dispersing medium (preferably, at least one selected from a fatty acid and oil/fat), surfactant, and thickener components, other additives may be further contained in an arbitrary ratio in the polishing composition of one embodiment if necessary as long as the effect of the present invention is not impaired. Examples of the other additives include pH adjusting agents, polymer compounds, antifungal agents (antiseptic agents), defoaming agents, dissolved gas, reducing agents, oxidizing agents, and alkanolamines. Known additives may be used for the other additives.

### [Method for Producing Polishing Composition]

A method for producing the polishing composition of the present invention includes the step of dispersing abrasive grains in a dispersing medium (for example, water or a fatty acid). Specifically, the method for producing the polishing composition of the present invention includes the steps of (a) adding abrasive grains and a surfactant to a first dispersing medium (for example, a fatty acid), and performing mixing to obtain an abrasive grain dispersion liquid; and if necessary, (b) adding a second dispersing medium (for example, oil/fat), and a thickener if necessary to the abrasive grain dispersion liquid, and performing mixing to obtain a polishing composition. Here, for the method for performing mixing for obtaining the abrasive grain dispersion liquid or the polishing composition, ultrasonic waves, a magnetic stirrer, a three-one motor, a homogenizer, or the like may be used. For mixing the abrasive grain dispersion liquid, it is preferable to perform the mixing using ultrasonic waves, and for mixing the polishing composition, it is preferable to perform the mixing using ultrasonic waves or a three-one motor.

When a fatty acid that is solid at room temperature is used as the first dispersing medium, a paste (abrasive grain dispersion liquid) can be prepared by heating the fatty acid to the melting point to liquefy the fatty acid, then adding abrasive grains to the fatty acid, and stirring the mixture to homogeneity, followed by cooling to room temperature. When a solid fatty acid is applied as the thickener, the solid fatty acid may be used as a dispersing medium to obtain a polishing composition as a paste, or abrasive grains may be once dispersed in a fatty acid, which is liquid at room temperature, to obtain an abrasive grain dispersion liquid, followed by addition of a fatty acid, which is solid at room temperature, to the abrasive grain dispersion liquid. Here, it is preferable that before being added to the abrasive grain dispersion liquid, the fatty acid that is solid at room temperature be heated at a temperature equal to or higher than the melting point of the fatty acid, and used in a liquid state.

### [Uses of Polishing Composition]

The polishing composition of one embodiment is suitably used for polishing metals, semiconductor substrates, glass, ceramics, resins, diamond, and the like, in particular, metals having a steric structure (metals having a three-dimensional shape). Examples of the metal having a three-dimensional shape include metallic molds.

That is, according to one embodiment, there is provided a polishing method comprising polishing a metal having a three-dimensional shape by use of the polishing composition of the present invention. According to one embodiment, there is also provided a method for producing a metallic mold, comprising the step of polishing a metallic mold using the polishing composition of the present invention.

Examples of the type of metal that is an object to be polished according to one embodiment include pre-hardened steels such as a mechanical structure carbon steel material SC type (for example, S50C), chrome molybdenum steel material SCM types (for example, P2RM and P3RMF), and a NAK type (precipitation-hardened) (for example, NAK80); quenched and tempered steels such as stainless steel (for example, STAVAX, HPM38S, and P12RM), alloy tool steel (for example, P9RM, D9RM1, and NAK101); and age-treated steels. The metallic molds produced from these metals are used as metallic molds for pressing, forging, casting, die casting, plastic, glass, rubber, powder metallurgy, and the like. Examples of the material molded with these metallic molds include steel sheets, nonferrous metals such as aluminum alloys and zinc alloys, glass materials, rubbers, and plastics such as polypropylene, polystyrene, ABC resins, polycarbonate (PC), acrylic resins such as polymethyl methacrylate (PMMA), polyethylene terephthalate (PET), polybutylene terephthalate (PBT), and fiber-reinforced plastic (FRP).

These metallic molds are used in the fields of automobile components, construction machine components, agriculture machine components, beverage containers, lighting fixture components, footwear, mold bases, bumpers, home electrical appliances, instrumental panels, TV cabinets, headlamps, optical equipment, OA equipment, smartphone/PC/camera housings, cosmetic bottles, lenses, optical disks, fiber-reinforced products, and the like. The polishing composition of the present invention may be used as a polishing composition for polishing a metallic mold used for performing molding in production of a product in any of the fields described above.

While embodiments of the present invention have been described in detail above, it is obvious that these embodiments are explanatory and illustrative, and are not limiting, and the scope of the present invention should be determined by the appended claims.

The present invention includes the following aspects and modes:
[1] a polishing composition comprising abrasive grains having a Mohs hardness of 8 or more, and a dispersing medium,
   wherein the abrasive grains have two or more local maximum points at different particle sizes in a volume-based particle size distribution measured by a porous electrical resistance method;
[2] the polishing composition according to [1], wherein in the abrasive grains, a ratio Dmin/Dmax of the smallest particle size (Dmin) to the largest particle size (Dmax) in the two or more local maximum points at different particle sizes is 0.1 or more and 0.9 or less;
[3] the polishing composition according to [1] or [2], wherein in the abrasive grains, Vs/Vt is 3.5 or less, where Vs is a volume-based frequency at a particle size e (Ds) on the small particle size side and Vt is a volume-based frequency at a particle size (Dt) on the large particle size side for the particle size with the largest volume-based frequency and the particle size with the second largest volume-based frequency in the two or more local maximum points at different particle sizes;
[4] the polishing composition according to any one of [1] to [3], wherein in the abrasive grains, Vmin/Vmax is 3.5 or less, where Vmin is a volume-based frequency at the smallest particle size (Dmin) and Vmax is a volume-based frequency at the largest particle size (Dmax) in the two or more local maximum points at different particle sizes;
[5] the polishing composition according to any one of [1] to [4], wherein the abrasive grains are diamond;
[6] the polishing composition according to [5], wherein the diamond is polycrystalline diamond;
[7] the polishing composition according to any one of [1] to [6], wherein the dispersing medium is one or more selected from the group consisting of a fatty acid and oil/fat;
[8] the polishing composition according to any one of [1] to [7], comprising one or more components selected from the group consisting of a surfactant and a thickener;
[9] the polishing composition according to [8], wherein the thickener is amorphous silica;
[10] the polishing composition according to any one of [1] to [9], further comprising a surfactant, the surfactant being a polyoxyalkylene fatty acid ester;
[11] a polishing method comprising polishing a metal having a three-dimensional shape by use of the polishing composition according to any one of [1] to [10]; and
[12] a method for producing a metallic mold, comprising the step of polishing a metallic mold using the polishing composition according to any one of [1] to [11].

### EXAMPLES

The present invention will be further described in detail by way of Examples and Comparative Examples below. However, the technical scope of the present invention is not limited only to the Examples below. Unless otherwise specified, the terms “%” and “parts” mean “mass %” and “parts by mass”, respectively. In the following Examples, the operations were performed under conditions of room temperature (25° C.) and a relative humidity of 40% RH or more and 50% RH or less unless otherwise specified.

### [Preparation of Polishing Compositions A1 to A17 and B1]

A diamond dispersion liquid was prepared by homogeneously stirring 4.9 parts by mass of single-crystalline diamond having local maximum points at particle sizes shown in Table 1, as abrasive grains, 14.2 parts by mass of a polyoxyethylene oleic acid ester (product name: NOIGEN ES-99D (DKS Co., Ltd.), HLB: 7.7) as a surfactant, and 14.2 parts by mass of a higher fatty acid (oleic acid) which is a fatty acid as a dispersing medium. To the diamond dispersion liquid, 46.9 parts by mass of oil/fat (olive oil) as a dispersing medium and 19.7 parts by mass of amorphous silica (product name: CARPLEX 30 (precipitated silica), average secondary particle size (D50): 15 μm) as a thickener were added, and the mixture was homogeneously kneaded. In this way, paste-like polishing compositions A1 to A17 and B1 were prepared.

### [Measurement of Particle Size Distribution of Diamond]

The particle size distribution of the diamond was measured with “Multisizer 4e” manufactured by Beckman Coulter, Inc. The aperture diameter was 20 μm.

### [Evaluation of Polishing Composition]

Evaluation was performed on the obtained polishing compositions A1 to A17 and B1 as below. Table 1 shows the evaluation results for the polishing compositions A1 to A17 and B1.

### [Polishing Rate]

The polishing rate for NAK80 polished under the following polishing conditions using the polishing composition was measured. Weights of the metallic mold material before and after polishing were measured, and a difference between the weights was taken as an amount of removal, and divided by the polishing time to calculate the polishing rate. A ratio of the polishing rate of the polishing composition Al to A17 to the polishing rate of the polishing composition B1 which was assumed to be 1.00 was calculated and showed as a Relative value of polishing rate in Table 1. This operation was performed three times, and an average thereof was given. Note that the polishing rate of the polishing composition B1 was 4 mg/min.

### [Time for Removing Scratch]

NAK80 was polished with #2000 sandpaper, followed by polishing with the polishing composition under the following polishing conditions. The surface was visually observed, and the time until removal of scratches caused by #2000 sandpaper was taken as a time for removing scratch (min).

### [Polishing Conditions]

Material: NAK80; size: 60 mm×60 mm×5 mm
Polishing machine: manufactured by Minitor Co., Ltd.
   MINIMO ONE SERIES VER. 2
   M112GRAD
Pad: ϕ30 felt (SA3103) manufactured by Minitor Co., Ltd.
Rotation speed: 1,000 rpm

TABLE 1

| | | Particle size distribution of abrasive grains | | | | | | | |
|---|---|---|---|---|---|---|---|---|---|
| | | Number | | | | | | | |
| | | of local | | | | | | | |
| | Polishing | maximum | Dmax | | Dmin | | Dt | | Ds |
| | composition | points | [μm] | Vmax | [μm] | Vmin | [μm] | Vt | [μm] |
| Example 1 | A1 | 2 | 4.21 | 3.70 | 0.50 | 0.80 | (=Dmax) | (=Vmax) | (=Dmin) |
| Example 2 | A2 | 2 | 4.21 | 3.76 | 1.06 | 0.87 | (=Dmax) | (=Vmax) | (=Dmin) |
| Example 3 | A3 | 2 | 4.27 | 4.28 | 1.49 | 0.14 | (=Dmax) | (=Vmax) | (=Dmin) |
| Example 4 | A4 | 2 | 4.21 | 4.18 | 1.51 | 0.36 | (=Dmax) | (=Vmax) | (=Dmin) |
| Example 5 | A5 | 2 | 4.27 | 3.64 | 1.47 | 0.81 | (=Dmax) | (=Vmax) | (=Dmin) |
| Example 6 | A6 | 2 | 4.59 | 1.23 | 1.65 | 1.73 | (=Dmax) | (=Vmax) | (=Dmin) |
| Example 7 | A7 | 2 | 4.46 | 1.10 | 1.67 | 3.48 | (=Dmax) | (=Vmax) | (=Dmin) |
| Example 8 | A8 | 2 | 4.46 | 4.91 | 2.01 | 0.72 | (=Dmax) | (=Vmax) | (=Dmin) |
| Example 9 | A9 | 2 | 4.46 | 4.58 | 2.01 | 0.95 | (=Dmax) | (=Vmax) | (=Dmin) |
| Example 10 | A10 | 2 | 4.59 | 4.25 | 2.01 | 1.18 | (=Dmax) | (=Vmax) | (=Dmin) |
| Example 11 | A11 | 2 | 4.59 | 3.74 | 2.01 | 1.55 | (=Dmax) | (=Vmax) | (=Dmin) |
| Example 12 | A12 | 2 | 4.39 | 3.00 | 1.99 | 2.62 | (=Dmax) | (=Vmax) | (=Dmin) |
| Example 13 | A13 | 2 | 4.59 | 1.96 | 1.99 | 2.98 | (=Dmax) | (=Vmax) | (=Dmin) |
| Example 14 | A14 | 2 | 4.72 | 1.54 | 2.01 | 2.80 | (=Dmax) | (=Vmax) | (=Dmin) |
| Example 15 | A15 | 2 | 4.46 | 1.39 | 1.99 | 3.54 | (=Dmax) | (=Vmax) | (=Dmin) |
| Example 16 | A16 | 2 | 4.59 | 4.13 | 2.58 | 0.95 | (=Dmax) | (=Vmax) | (=Dmin) |
| Example 17 | A17 | 2 | 4.59 | 4.09 | 3.02 | 0.96 | (=Dmax) | (=Vmax) | (=Dmin) |
| Comparative | B1 | 1 | 4.39 | 5.56 | — | — | — | — | — |
| Example 1 | | | | | | | | | |

| | | | | | | Relative | Time for |
|---|---|---|---|---|---|---|---|
| | | | | | | value of | removing |
| | Particle size distribution of abrasive grains | | | | | polishing | scratch |
| | Vs | Dmin/Dmax | Ds/Dt | Vmin/max | Vs/Vt | rate | [min] |
| Example 1 | (=Vmin) | 0.12 | 0.12 | 0.21 | 0.21 | 1.20 | 7 |
| Example 2 | (=Vmin) | 0.25 | 0.25 | 0.23 | 0.23 | 1.23 | 7 |
| Example 3 | (=Vmin) | 0.35 | 0.35 | 0.03 | 0.03 | 1.50 | 6 |
| Example 4 | (=Vmin) | 0.36 | 0.36 | 0.09 | 0.09 | 1.48 | 6 |
| Example 5 | (=Vmin) | 0.34 | 0.34 | 0.22 | 0.22 | 2.16 | 4 |
| Example 6 | (=Vmin) | 0.36 | 0.36 | 1.41 | 1.41 | 1.64 | 6 |
| Example 7 | (=Vmin) | 0.37 | 0.37 | 3.16 | 3.16 | 1.18 | 7 |
| Example 8 | (=Vmin) | 0.45 | 0.45 | 0.15 | 0.15 | 1.23 | 7 |
| Example 9 | (=Vmin) | 0.45 | 0.45 | 0.21 | 0.21 | 2.61 | 3 |
| Example 10 | (=Vmin) | 0.44 | 0.44 | 0.28 | 0.28 | 2.61 | 3 |
| Example 11 | (=Vmin) | 0.44 | 0.44 | 0.41 | 0.41 | 2.52 | 3 |
| Example 12 | (=Vmin) | 0.45 | 0.45 | 0.87 | 0.87 | 2.27 | 4 |
| Example 13 | (=Vmin) | 0.43 | 0.43 | 1.52 | 1.52 | 2.23 | 4 |
| Example 14 | (=Vmin) | 0.43 | 0.43 | 1.82 | 1.82 | 2.18 | 4 |
| Example 15 | (=Vmin) | 0.45 | 0.45 | 2.55 | 2.55 | 1.84 | 5 |
| Example 16 | (=Vmin) | 0.56 | 0.56 | 0.23 | 0.23 | 2.20 | 4 |
| Example 17 | (=Vmin) | 0.66 | 0.66 | 0.23 | 0.23 | 1.25 | 7 |
| Comparative | — | — | — | — | — | 1.00 | 8 |
| Example 1 | | | | | | | |

### [Preparation of Polishing Compositions A18 to A21 and B2]

Paste-like polishing compositions A18 to A21 and B2 were prepared by the same method as that for the polishing compositions A1 to A17 and B1 except that 4.9 parts by mass of single-crystalline diamond having local maximum points at particle sizes shown in Table 2 was used as abrasive grains. The particle size distributions of diamond shown in Table 2 were measured with “Multisizer 4e” manufactured by Beckman Coulter, Inc. The aperture diameter was 20 μm.

### [Evaluation of Polishing Composition]

Evaluation was performed on the obtained polishing compositions A18 to A21 and B2 in the same manner as in the case of the polishing compositions A1 to A17 and B1 except that a ratio of the polishing rate of the polishing composition A18 to A21 to the polishing rate of the polishing composition B2 which was assumed to be 1.00 was calculated. Note that the polishing rate of the polishing composition B2 was 3 mg/min. Table 2 shows the evaluation results as a Relative value of polishing rate.

### [Preparation of Polishing Compositions A22 to A25 and B3]

Paste-like polishing compositions A22 to A25 and B3 were prepared by the same method as that for the polishing compositions A1 to A17 and B1 except that 4.9 parts by mass of single-crystalline diamond having local maximum points at particle sizes shown in Table 3 was used as abrasive grains. The particle size distributions of diamond shown in Table 3 were measured with “Multisizer 4e” manufactured by Beckman Coulter, Inc. The aperture diameter was 50 μm.

### [Evaluation of Polishing Composition]

Evaluation was performed on the obtained polishing compositions A22 to A25 and B3 in the same manner as in the case of the polishing compositions A1 to A17 and B1 except that a ratio of the polishing rate of the polishing composition A22 to A25 to the polishing rate of the polishing composition B3 which was assumed to be 1.00 was calculated. Note that the polishing rate of the polishing composition B3 was 1 mg/min. Table 3 shows the evaluation results as a Relative value of polishing rate.

### [Preparation of Polishing Compositions A26, A28, A31, and B4]

Paste-like polishing compositions A26, A28, A31, and B4 were prepared by adding 3.5 parts by mass of single-crystalline diamond having local maximum points at particle sizes shown in Table 4, as abrasive grains, a surfactant X1 or X2 formulated as shown in Table 4, as a surfactant, 5 parts by mass of fumed silica (product name: AEROSIL 200, manufactured by NIPPON AEROSIL CO., LTD., average primary particle size (D50): 12 nm) as a thickener, and a polyoxyalkylene glycol (product name: NEWPOL 50HB-400, manufactured by Sanyo Chemical Industries, Ltd.) as a dispersing medium in an amount equal to the balance when the total amount of the composition was assumed to be 100 parts by mass, and homogeneously kneading the mixture. In the fields of “Formulation of polishing composition” in Table 4, the notation “-” means that the relevant component was not blended. The surfactant X1 or X2 is the following compound.
Surfactant X1: polyoxyethylene oleic acid ester (product name: NOIGEN ES-99D, manufactured by DKS Co., Ltd.) (another name: polyoxyethylene monooleate)
Surfactant X2: polyoxyethylene alkyl (C12-14) ether (product name: FINE SURF 290, manufactured by Aoki Oil Industrial Co., Ltd.)

### [Preparation of Polishing Compositions A27, A29, and A30]

A diamond dispersion liquid was prepared by homogeneously stirring 3.5 parts by mass of single-crystalline diamond having local maximum points at particle sizes shown in Table 4, as abrasive grains, a surfactant X1 or X2 formulated as shown in Table 4, as a surfactant, and a higher fatty acid (oleic acid) formulated as shown in Table 4, as a dispersing medium. To the diamond dispersion liquid, 5 parts by mass of fumed silica (product name: AEROSIL 200, manufactured by NIPPON AEROSIL CO., LTD., average primary particle size (D50): 12 nm) as a thickener and a polyoxyalkylene glycol (product name: NEWPOL 50HB-400, manufactured by Sanyo Chemical Industries, Ltd.) as a dispersing medium in an amount equal to the balance when the total amount of the composition was assumed to be 100 parts by mass were added, and the mixture was homogeneously kneaded. In this way, paste-like polishing compositions A27, A29, and A30 were prepared. The particle size distributions of diamond shown in Table 4 were measured with “Multisizer 4e” manufactured by Beckman Coulter, Inc. The aperture diameter was 20 μm.

### [Evaluation of Polishing Composition]

Evaluation was performed on the obtained polishing compositions A26 to A31 and B4 in the same manner as in the case of the polishing compositions A1 to A17 and B1 except that a ratio of the polishing rate of the polishing composition A26 to A31 to the polishing rate of the polishing composition B4 which was assumed to be 1.00 was calculated. Note that the polishing rate of the polishing composition B4 was 4 mg/min. Table 4 shows the evaluation results as a Relative value of polishing rate.

TABLE 2

| | | Particle size distribution of abrasive grains | | | | | | | |
|---|---|---|---|---|---|---|---|---|---|
| | | Number | | | | | | | |
| | | of local | | | | | | | |
| | Polishing | maximum | Dmax | | Dmin | | Dt | | Ds |
| | composition | points | [μm] | Vmax | [μm] | Vmin | [μm] | Vt | [μm] |
| Example 18 | A18 | 2 | 2.04 | 3.78 | 1.07 | 0.84 | (=Dmax) | (=Vmax) | (=Dmin) |
| Example 19 | A19 | 2 | 2.04 | 3.36 | 1.47 | 0.70 | (=Dmax) | (=Vmax) | (=Dmin) |
| Example 20 | A20 | 2 | 4.27 | 0.79 | 1.99 | 3.70 | (=Dmax) | (=Vmax) | (=Dmin) |
| Example 21 | A21 | 2 | 4.46 | 1.02 | 1.99 | 3.63 | (=Dmax) | (=Vmax) | (=Dmin) |
| Comparative | B2 | 1 | 2.01 | 5.57 | — | — | — | — | — |
| Example 2 | | | | | | | | | |

| | | | | | | Relative | Time for |
|---|---|---|---|---|---|---|---|
| | | | | | | value of | removing |
| | Particle size distribution of abrasive grains | | | | | polishing | scratch |
| | Vs | Dmin/Dmax | Ds/Dt | Vmin/Vmax | Vs/Vt | rate | [min] |
| Example 18 | (=Vmin) | 0.52 | 0.52 | 0.22 | 0.22 | 3.22 | 5 |
| Example 19 | (=Vmin) | 0.72 | 0.72 | 0.21 | 0.21 | 2.46 | 6 |
| Example 20 | (=Vmin) | 0.47 | 0.47 | 4.68 | 4.68 | 1.31 | 10 |
| Example 21 | (=Vmin) | 0.45 | 0.45 | 3.56 | 3.56 | 1.37 | 10 |
| Comparative | — | — | — | — | — | 1.00 | 14 |
| Example 2 | | | | | | | |

TABLE 3

| | | Particle size distribution of abrasive grains | | | | | | | |
|---|---|---|---|---|---|---|---|---|---|
| | | Number | | | | | | | |
| | | of local | | | | | | | |
| | Polishing | maximum | Dmax | | Dmin | | Dt | | Ds |
| | composition | points | [μm] | Vmax | [μm] | Vmin | [μm] | Vt | [μm] |
| Example 22 | A22 | 3 | 6.40 | 0.70 | 2.61 | 0.93 | 4.66 | 2.94 | 2.61 |
| Example 23 | A23 | 3 | 7.28 | 0.68 | 2.81 | 0.65 | 7.28 | 0.68 | 4.52 |
| Example 24 | A24 | 2 | 7.18 | 1.87 | 4.46 | 1.24 | (=Dmax) | (=Vmax) | (=Dmin) |
| Example 25 | A25 | 2 | 8.66 | 2.67 | 4.59 | 1.05 | (=Dmax) | (=Vmax) | (=Dmin) |
| Comparative | B3 | 1 | 8.66 | 3.55 | — | — | — | — | — |
| Example 3 | | | | | | | | | |

| | | | | | | Relative | Time for |
|---|---|---|---|---|---|---|---|
| | | | | | | value of | removing |
| | Particle size distribution of abrasive grains | | | | | polishing | scratch |
| | Vs | Dmin/Dmax | Ds/Dt | Vmin/Vmax | Vs/Vt | rate | [min] |
| Example 22 | 0.93 | 0.41 | 0.56 | 1.33 | 0.32 | 11.18 | 3 |
| Example 23 | 2.22 | 0.39 | 0.62 | 0.96 | 3.26 | 9.91 | 4 |
| Example 24 | (=Vmin) | 0.62 | 0.62 | 0.66 | 0.66 | 5.64 | 6 |
| Example 25 | (=Vmin) | 0.53 | 0.53 | 0.39 | 0.39 | 4.73 | 8 |
| Comparative | — | — | — | — | — | 1.00 | Not |
| Example 3 | | | | | | | removed |

TABLE 4

| | | | | | | | | | | Evaluation of | |
|---|---|---|---|---|---|---|---|---|---|---|---|
| | | Particle size distribution of abrasive grains | | | | | | | | performance | |
| | | Number | | | | | Formulation of polishing composition | | | Relative | Time for |
| | | of local | | | | | Surfactant | Surfactant | Fatty acid | value of | removing |
| | Polishing | maximum | Dmax | | Dmin | | X1 (parts | X2 (parts | (parts | polishing | scratch |
| | composition | points | [μm] | Vmax | [μm] | Vmin | by mass) | by mass) | by mass) | rate | [min] |
| Example 26 | A26 | 2 | 4.59 | 4.25 | 2.01 | 1.18 | — | — | — | 1.37 | 6 |
| Example 27 | A27 | 2 | 4.59 | 4.25 | 2.01 | 1.18 | — | — | 14.2 | 1.55 | 5 |
| Example 28 | A28 | 2 | 4.59 | 4.25 | 2.01 | 1.18 | 14.2 | — | — | 1.53 | 5 |
| Example 29 | A29 | 2 | 4.59 | 4.25 | 2.01 | 1.18 | 14.2 | — | 14.2 | 1.90 | 4 |
| Example 30 | A30 | 2 | 4.59 | 4.25 | 2.01 | 1.18 | 6.2 | — | 6.2 | 2.49 | 3 |
| Example 31 | A31 | 2 | 4.59 | 4.25 | 2.01 | 1.18 | — | 14.2 | — | 1.05 | 7 |
| Comparative | B4 | 1 | 4.39 | 5.56 | — | — | — | — | — | 1.00 | 8 |
| Example 4 | | | | | | | | | | | |

### [Preparation of Polishing Compositions A32 and B5]

A diamond dispersion liquid was prepared by homogeneously stirring 3.5 parts by mass of polycrystalline diamond having local maximum points at particle sizes shown in Table 5, as abrasive grains, a surfactant X1 formulated as shown in Table 5, as a surfactant, and a higher fatty acid (oleic acid) formulated as shown in Table 5, as a dispersing medium. To the diamond dispersion liquid, 8 parts by mass of fumed silica (product name: AEROSIL 200, manufactured by NIPPON AEROSIL CO., LTD., average primary particle size (D50): 12 nm) as a thickener and a polyoxyalkylene glycol (product name: NEWPOL LB-625, manufactured by Sanyo Chemical Industries, Ltd.) as a dispersing medium in an amount equal to the balance when the total amount of the composition was assumed to be 100 parts by mass were added, and the mixture was homogeneously kneaded. In this way, paste-like polishing compositions A32 and B5 were prepared.

### [Preparation of Polishing Compositions A33 and B6]

Paste-like polishing compositions A33 and B63 were prepared by the same method as that for the polishing compositions A32 and B5 except that 3.5 parts by mass of single-crystalline diamond having local maximum points at particle sizes shown in Table 5 was used as abrasive grains. The particle size distributions of diamond shown in Table 5 were measured with “Multisizer 4e” manufactured by Beckman Coulter, Inc. The aperture diameter was 20 μm.

### [Evaluation of Polishing Composition]

Evaluation was performed on the obtained polishing compositions A32, A33, B5 and B6 in the same manner as in the case of the polishing compositions A1 to A17 and B1 except that a ratio of the polishing rate of the polishing composition A32, A33 and B6 to the polishing rate of the polishing composition B5 which was assumed to be 1.00 was calculated. Note that the polishing rate of the polishing composition B5 was 8 mg/min. Table 5 shows the evaluation results as a Relative value of polishing rate.

### [Preparation of Polishing Compositions A34 and B7]

A silicon carbide dispersion liquid was prepared by homogeneously stirring 3.5 parts by mass of silicon carbide having local maximum points at particle sizes shown in Table 6, as abrasive grains, a surfactant X1 formulated as shown in Table 6, as a surfactant, and a higher fatty acid (oleic acid) formulated as shown in Table 6, as a dispersing medium. To the silicon carbide dispersion liquid, 8 parts by mass of fumed silica (product name: AEROSIL 200, manufactured by NIPPON AEROSIL CO., LTD., average primary particle size (D50): 12 nm) as a thickener and a polyoxyalkylene glycol (product name: NEWPOL LB-625, manufactured by Sanyo Chemical Industries, Ltd.) as a dispersing medium in an amount equal to the balance when the total amount of the composition was assumed to be 100 parts by mass were added, and the mixture was homogeneously kneaded. In this way, paste-like polishing compositions A34 and B7 were prepared. The particle size distributions of silicon carbide shown in Table 6 were measured with “Multisizer 4e” manufactured by Beckman Coulter, Inc. The aperture diameter was 20 μm.

### [Evaluation of Polishing Composition]

Evaluation was performed on the obtained polishing compositions A34 and B7 in the same manner as in the case of the polishing compositions A1 to A17 and B1 except that a ratio of the polishing rate of the polishing composition A34 to the polishing rate of the polishing composition B7 which was assumed to be 1.00 was calculated. Note that the polishing rate of the polishing composition B7 was 3 mg/min. Table 6 shows the evaluation results as a Relative value of polishing rate.

TABLE 5

| | | | | | | | | | | Evaluation of | |
|---|---|---|---|---|---|---|---|---|---|---|---|
| | | | Particle size distribution of abrasive grains | | | | | Formulation of | | performance | |
| | | | Number | | | | | polishing composition | | Relative | Time for |
| | | | of local | | | | | Surfactant | Surfactant | value of | removing |
| | Polishing | Abrasive | maximum | Dmax | | Dmin | | X1 (parts | X2 (parts | polishing | scratch |
| | composition | grains | points | [μm] | Vmax | [μm] | Vmin | by mass) | by mass) | rate | [min] |
| Example 32 | A32 | polycrystalline | 2 | 5.62 | 4.04 | 2.26 | 0.92 | 14.2 | 14.2 | 1.73 | 2 |
| | | diamond | | | | | | | | | |
| Example 33 | A33 | single- | 2 | 4.59 | 4.25 | 2.01 | 1.18 | 14.2 | 14.2 | 1.32 | 3 |
| | | crystalline | | | | | | | | | |
| | | diamond | | | | | | | | | |
| Comparative | B5 | polycrystalline | 1 | 5.62 | 5.17 | — | — | 14.2 | 14.2 | 1.00 | 4 |
| Example 5 | | diamond | | | | | | | | | |
| Comparative | B6 | single- | 1 | 4.39 | 5.56 | — | — | 14.2 | 14.2 | 0.62 | 6 |
| Example 6 | | crystalline | | | | | | | | | |
| | | diamond | | | | | | | | | |

TABLE 6

| | | | | | | | | | | Evaluation of | |
|---|---|---|---|---|---|---|---|---|---|---|---|
| | | | Particle size distribution of abrasive grains | | | | | Formulation of | | performance | |
| | | | Number | | | | | polishing composition | | Relative | Time for |
| | | | of local | | | | | Surfactant | Surfactant | value of | removing |
| | Polishing | Abrasive | maximum | Dmax | | Dmin | | X1 (parts | X2 (parts | polishing | scratch |
| | composition | grains | points | [μm] | Vmax | [μm] | Vmin | by mass) | by mass) | rate | [min] |
| Example 34 | A34 | silicon | 2 | 3.91 | 1.80 | 1.92 | 0.71 | 14.2 | 14.2 | 1.28 | 7 |
| | | carbide | | | | | | | | | |
| Comparative | B7 | silicon | 1 | 4.00 | 2.30 | — | — | 14.2 | 14.2 | 1.00 | 9 |
| Example 7 | | carbide | | | | | | | | | |

As shown in Tables 1 to 6, it was confirmed that the polishing compositions of the Examples comprising abrasive grains having two or more local maximum points at different particle sizes exhibited a high polishing rate, shortened the time for removing scratch, had good polishing performance, and enabled reduction of the operation time. On the other hand, the polishing compositions of the Comparative Examples comprising abrasive grains having one local maximum point were found to be inferior in the results of the polishing rate and the time for removing scratch to the polishing compositions of the Examples.

The present application is based on Japanese Patent Application No. 2023-010768 filed on Jan. 27, 2023, Japanese Patent Application No. 2023-169153 filed on Sep. 29, 2023, and Japanese Patent Application No. 2024-7213 filed on Jan. 22, 2024, the disclosures of which are incorporated by reference in their entirety.

1. A polishing composition comprising abrasive grains having a Mohs hardness of 8 or more, and a dispersing medium,
wherein the abrasive grains have two or more local maximum points at different particle sizes in a volume-based particle size distribution measured by a porous electrical resistance method.

2. The polishing composition according to claim 1, wherein in the abrasive grains, a ratio Dmin/Dmax of the smallest particle size (Dmin) to the largest particle size (Dmax) in the two or more local maximum points at different particle sizes is 0.1 or more and 0.9 or less.

3. The polishing composition according to claim 1, wherein in the abrasive grains, Vs/Vt is 3.5 or less, where Vs is a volume-based frequency at a particle size (Ds) on the small particle size side and Vt is a volume-based frequency at a particle size (Dt) on the large particle size side for the particle size with the largest volume-based frequency and the particle size with the second largest volume-based frequency in the two or more local maximum points at different particle sizes.

4. The polishing composition according to claim 1, wherein in the abrasive grains, Vmin/Vmax is 3.5 or less, where Vmin is a volume-based frequency at the smallest particle size (Dmin) and Vmax is a volume-based frequency at the largest particle size (Dmax) in the two or more local maximum points at different particle sizes.

5. The polishing composition according to claim 1, wherein the abrasive grains are diamond.

6. The polishing composition according to claim 5, wherein the diamond is polycrystalline diamond.

7. The polishing composition according to claim 1, wherein the dispersing medium is one or more selected from the group consisting of a fatty acid and oil/fat.

8. The polishing composition according to claim 1, comprising one or more components selected from the group consisting of a surfactant and a thickener.

9. The polishing composition according to claim 8, wherein the thickener is amorphous silica.

10. The polishing composition according to claim 1, further comprising a surfactant, the surfactant being a polyoxyalkylene fatty acid ester.

11. A polishing method comprising polishing a metal having a three-dimensional shape by use of the polishing composition according to claim 1.

12. A method for producing a metallic mold, comprising the step of polishing a metallic mold using the polishing composition according to claim 1.

13. The polishing composition according to claim 2, wherein in the abrasive grains, Vs/Vt is 3.5 or less, where Vs is a volume-based frequency at a particle size (Ds) on the small particle size side and Vt is a volume-based frequency at a particle size (Dt) on the large particle size side for the particle size with the largest volume-based frequency and the particle size with the second largest volume-based frequency in the two or more local maximum points at different particle sizes.

14. The polishing composition according to claim 2, wherein in the abrasive grains, Vmin/Vmax is 3.5 or less, where Vmin is a volume-based frequency at the smallest particle size (Dmin) and Vmax is a volume-based frequency at the largest particle size (Dmax) in the two or more local maximum points at different particle sizes.

15. The polishing composition according to claim 2, wherein the abrasive grains are diamond.

16. The polishing composition according to claim 15, wherein the diamond is polycrystalline diamond.

17. The polishing composition according to claim 2, wherein the dispersing medium is one or more selected from the group consisting of a fatty acid and oil/fat.

18. The polishing composition according to claim 2, comprising one or more components selected from the group consisting of a surfactant and a thickener.

19. The polishing composition according to claim 18, wherein the thickener is amorphous silica.

20. The polishing composition according to claim 2, further comprising a surfactant, the surfactant being a polyoxyalkylene fatty acid ester.
